(19) United States
(12) Patent Application Publication
(10) Pub. No.: US 2018/0298502 A1
(43) Pub. Date: Oct. 18, 2018

(54) CORROSION PROTECTION ARRANGEMENT

(71) Applicant: RKW SE, Frankenthal (DE)

(72) Inventors: Jan Eubeler, Grosskarlbach (DE); Tilo Wachs, Remagen (DE); Leonhard Maier, Babensham (DE); Robert Voggenauer, Wasserburg (DE)

(73) Assignee: RKW SE, Frankenthal (DE)

(21) Appl. No.: 15/510,833

(22) PCT Filed: Aug. 13, 2015
(86) PCT No.: PCT/EP2015/001672

§ 371 Date: Mar. 13, 2017

(30) Foreign Application Priority Data
Sep. 13, 2014 (DE) 10 2014 013 288.9

(51) Int. Cl. C23F 11/02; B32B 3/30; B32B 7/12; B32B 27/06; B32B 37/12

(52) U.S. Cl. CPC C23F 11/02; B32B 3/30; B32B 7/12; B32B 2553/00; B32B 37/12; B32B 2307/752; B32B 27/06

(57) ABSTRACT

The invention relates to a corrosion protection arrangement comprising an adhesive layer (11). The adhesive layer (11) contains at least one volatile corrosion inhibitor (12). The adhesive layer (11) sticks to a surface (23). The adhesive layer (11) bonds an outer layer (13) to the surface (23). The outer layer (13) has a multitude of orifices (14) for release of the volatile corrosion inhibitor (12). The outer layer (13) has protuberances (15) which project out of a plane (16) of the outer layer (13) by a height (17).

The invention relates to a corrosion protection arrangement comprising an adhesive layer containing at least one volatile corrosion inhibitor, wherein the adhesive layer sticks to a surface and the adhesive layer bonds an outer layer to the surface, wherein the outer layer has a multitude of orifices for release of the volatile corrosion inhibitor.

“Volatile corrosion inhibitors” (VCIs) are substances which protect metallic materials from corrosion from the vapor phase. Volatile corrosion inhibitors display their effect at the metal surface where they are adsorbed and form a protective layer against the effects of oxygen and/or water. They are notable for a high vapor pressure at relatively low temperatures.

Volatile corrosion inhibitors used may, for example, be salts having gradual outgassing, for example nitrite compounds or amine salts, such as dicyclohexylamine benzoate or diethanolamine nitrite. If the workpiece to be protected is enclosed by a packaging material, atmosphere saturated with the inhibitor is established. After the workpiece has been unpacked, the inhibitor is lost by volatilization without residues.

There are known corrosion protection arrangements in which active VCI ingredients are applied directly to surfaces such as polymer films, papers, cardboard or composite materials. The corrosion inhibitors are usually released again very rapidly in these arrangements. This leads to rapid and initially effective corrosion protection, but it does not last very long.

EP 0 825 019 A2 describes a corrosion protection arrangement in which a corrosion inhibitor is introduced into an adhesive. The corrosion inhibitor is added to the hotmelt adhesive in order to fix an outer layer in the form of a nonwoven material on a surface in the form of a shrink film.

EP 2 457 726 A1 describes a corrosion protection arrangement comprising an adhesive layer containing at least one volatile corrosion inhibitor, wherein the adhesive layer sticks to a surface and the adhesive layer bonds an outer layer to the surface. The surface is formed by a polyethylene film. The outer layer is formed by a nonwoven material. The nonwoven material consists of a spunbonded polypropylene web.

EP 2 184 162 A1 describes a temporary corrosion protection arrangement for construction steel components. The surface used is a polypropylene film. The outer layer used is a nonwoven. The surface and the outer layer are bonded with a VCI-containing adhesive.

EP 2 615 145 A2 describes a process for producing a packaging material for corrosion-prone articles made of metal. An adhesive layer is applied to a surface in the form of a polymer film. It contains a volatile corrosion inhibitor (VCI). Using the VCI-containing adhesive, a gas-permeable outer layer is laminated onto the polymer film, such that the adhesive is embedded between a polymer film-facing surface of the outer layer and bonds the layers to one another. The outer layer may consist of a textile material or a porous or perforated film. The adhesive penetrates into the outer layer.

It is an object of the invention to specify a corrosion protection arrangement in which the corrosion inhibitor is released from the adhesive layer over a maximum period of time. Moreover, there is to be avoidance of direct contact of the corrosion- prone articles with the inhibitors. The corrosion inhibitors are to display maximum efficiency. Moreover, the arrangement is to be notable for a high reliability and a stable structure. The arrangement is also to be appealing to potential customers and to be inexpensive to manufacture.

This object is achieved in accordance with the invention by an arrangement having the features of claim 1 and a process for producing such an arrangement having the features of claim 14. Preferred variants are detailed in the dependent claims.

According to the invention, the outer layer has protuberances which project out of a plane of the outer layer by a height. These protuberances create spacers to the adhesive layer. This construction particularly effectively prevents contact of the corrosion-prone articles with the adhesive layer containing the corrosion inhibitors.

In a particularly favorable execution of the invention, the protuberances form orifices. For this purpose, each protuberance has a wall which forms a cavity and surrounds an orifice. This type of protuberances may comprise cylindrical, conical and/or hyperboloid structures which project from the plane of the outer layer, and the edges of which form the orifices from which the volatile corrosion inhibitors exit. They are preferably longitudinal, tunnel-like capillaries through which the corrosion inhibitor migrates.

The walls of the protuberances form snorkels which guide inhibitors from the adhesive layer to the orifice. The cavities provide protection from effects, for example of an air flow, such that the active corrosion-inhibiting ingredient can first accumulate in the capillary-like cavities. This leads to improved efficacy.

In a particularly advantageous execution of the invention, the protuberances are produced in the outer layer by guiding thermoplastic material through an element having holes. Preferably, the element is a rotating roller. The roller has bores as holes. By means of a reduced pressure apparatus, a pressure differential is generated, such that the thermoplastic material is drawn into the holes. This results in thinning-out of the thermoplastic material in the region of the holes, such that orifices form in the outer layer. This results in formation of an outer layer having protuberances with cooling of the thermoplastic material. This vacuum-perforated outer layer is bonded to a surface via an active ingredient-containing adhesive layer.

The thermoplastic material can be guided through the element in different ways. In one variant, the thermoplastic material is extruded onto the element as a melt. In this case, the thermoplastic polymer film is supplied to a vacuum perforation apparatus in the molten state. The polymer film is sucked into the holes by means of a reduced pressure apparatus, and the polymer melt forms elongated cavities in the form of capillaries. After the film has cooled down, the vacuum-perforated outer layer is removed and bonded to a further layer by means of an adhesive layer.

In another variant of the process, a thermoplastic film is heated and guided through an element having holes. Here too, a reduced pressure is applied. The heated film is drawn in in the region of the holes, so as to form protuberances having a wall which form an elongated cavity and surround an orifice.

The height of the protuberance is preferably greater by a factor of 5, especially by a factor of 10, than the thickness of the plane of the outer layer. The height of the protuberance is preferably more than 100 μm, especially more than 300 μm. This gives rise to elongated capillaries having an air-filled cavity in which the corrosion-inhibiting active ingredient accumulates. The height of the protuberances is preferably less than 1500 μm, especially less than 1000 μm.

The protuberances may be in conical form, such that the narrowest cross section is formed by the outer edge of the protuberance. It is also possible to form cylindrical protuberances in which the cross section of the cavity remains substantially constant.

In a particularly advantageous execution of the invention, the protuberances have constrictions. Proceeding from a narrowest cross section, the free cross section of the cavity increases toward the orifice.

In one variant of the invention, the plane of the outer layer lies on the adhesive layer, and the protuberances project outward and away from the adhesive layer. From the adhesive layer, the volatile corrosion inhibitors enter the cavities of the protuberances and then exit through orifices which are formed by the outer edge of the protuberances.

In an alternative variant of the invention, the plane of the outer layer is arranged spaced apart from the adhesive layer. The projections project from the plane of the outer layer towards the adhesive layer. The orifices are in the plane of the outer layer, while the edges of the protuberances project towards the adhesive layer. In this variant of the invention, spaces are formed between adjacent protuberances, in which the active corrosion-inhibiting ingredient accumulates.

Preferably, the outer edge of the protuberances has an irregularly lobed and/or folded form. This allows active ingredient-rich air to diffuse from the spaces between adjacent protuberances into the cavities of the protuberances and thence to exit through the orifices.

In the production of the arrangement, the adhesive is applied to the outer layer and/or the surface as an adhesive layer. The adhesive may be applied to a surface in the form of a continuous carrier layer, for example with an engraved roller. The adhesive can also be knife-coated onto the carrier layer. The carrier layer and the outer layer are then laminated to one another via the adhesive layer.

Because of the comparatively high protuberances, a particularly pleasant “soft-touch” feel is achieved.

The adhesive layer serves firstly as a carrier for the volatile anticorrosive and simultaneously binds the outer layer of the surface. In a particularly favorable variant of the invention, the adhesive layer is formed by an isocyanate-based adhesive containing a volatile corrosion inhibitor (VCI).

The adhesive layer sticks to a surface. This may be the surface of an article.

The surface may also be formed by a further outer layer likewise having orifices. In this variant of the invention, the adhesive layer bonds two outer layers to one another. This is a composite having a middle adhesive layer and two outer layers. It is thus possible for a corrosion inhibitor to be released from the adhesive layer through the orifices in the outer layers on two sides.

In a particularly advantageous variant of the invention, the surface is a continuous carrier layer, preferably a film of polyethylene, polypropylene, polystyrene, polyethylene terephthalates, polyvinyl chloride, polylactide, thermoplastic polyurethane or coated cellulose film, and blends.

In this variant, the adhesive layer bonds the carrier layer to the outer layer. In one variant of the invention, an adhesive layer sticks to both sides of a carrier layer, in which case each adhesive layer bonds one outer layer to the carrier layer. This is a composite in which the carrier layer is arranged in the middle between two adhesive layers and two outer layers. Thus, the active corrosion-inhibiting ingredient can be released from the adhesive layers through the orifices into the outer layers on two sides.

In the arrangement of the invention, the outer layer is permanently bonded to the surface via the adhesive layer. In the case of use of the arrangement, the outer layer remains on the adhesive layer and provides protection of the corrosion-prone articles and the user from direct contact with the adhesive layer during use. In addition, the adhesive layer is prevented from drying out. For migration of the corrosion inhibitor from the adhesive layer, the outer layer has a multitude of orifices through which the active ingredient exits.

Preferably, the outer layer consists of a thermoplastic material which is otherwise closed except for the orifices. It is found to be particularly advantageous when the outer layer consists of a polyolefin. Examples of suitable materials for the outer layer are polyethylene or polypropylene, but also polystyrene, polyethylene terephthalates, polyvinyl chloride, polylactide, thermoplastic polyurethane or coated cellulose film, and also blends.

Apart from the orifices, the outer layer has a surface impermeable to the active ingredient. The region of the surface through which the active ingredient can exit is referred to as the “open area”. Preferably, the open area is more than 2%, preferably more than 3%, especially more than 4%. The open area is preferably less than 50%, especially less than 40%. It is found to be particularly favorable when the open area is in the range between 4% and 35%.

Further advantages and features of the invention will be apparent from the description of working examples with reference to drawings and from the drawings themselves. The figures show:

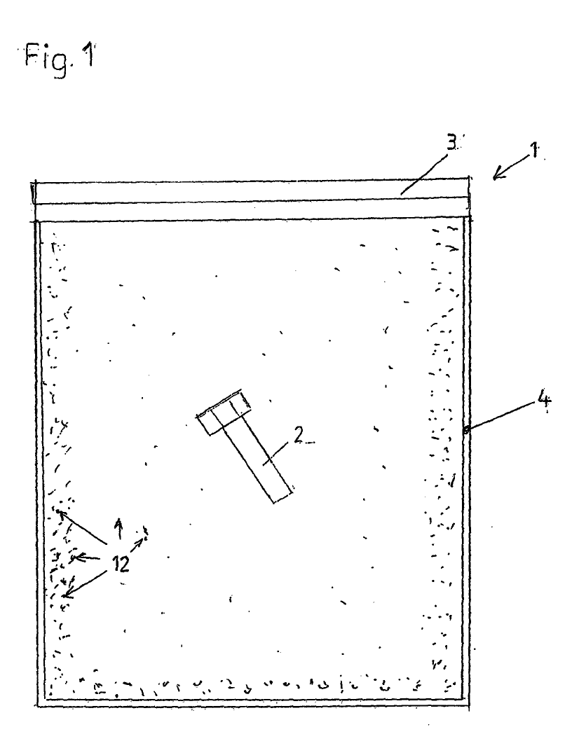

FIG. 1 a bag for corrosion protection,

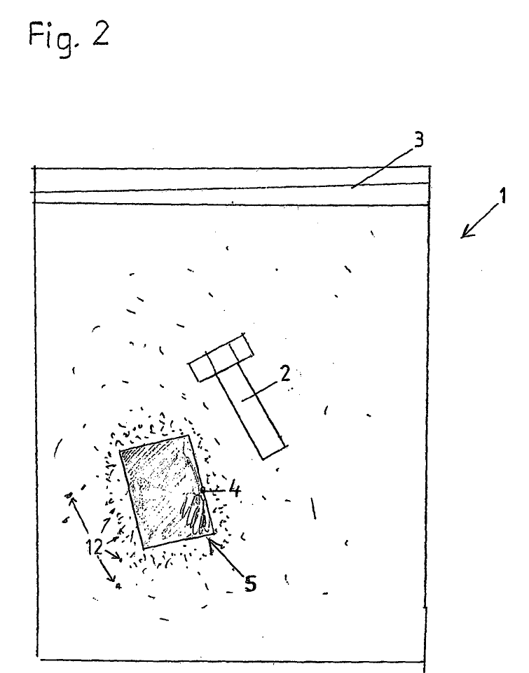

FIG. 2 a bag with an inlay for corrosion protection,

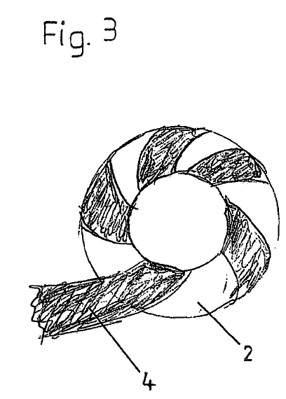

FIG. 3 a tape for corrosion protection,

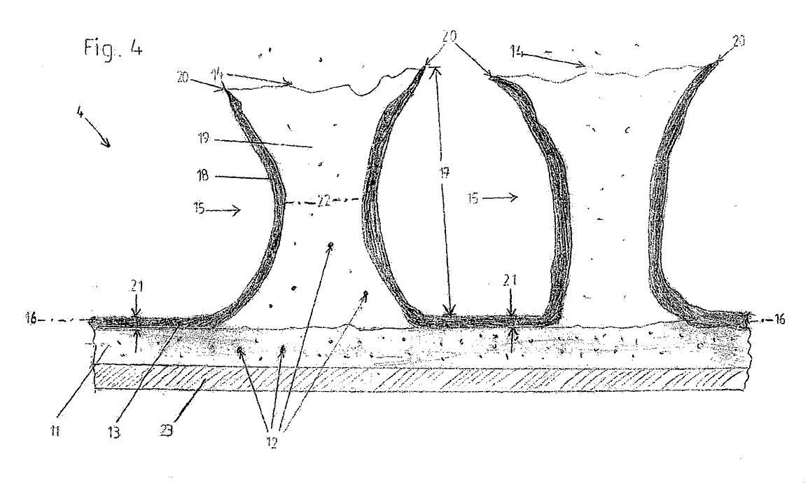

FIG. 4 a section view through a composite having an outer layer wherein the protuberances project away from the adhesive layer,

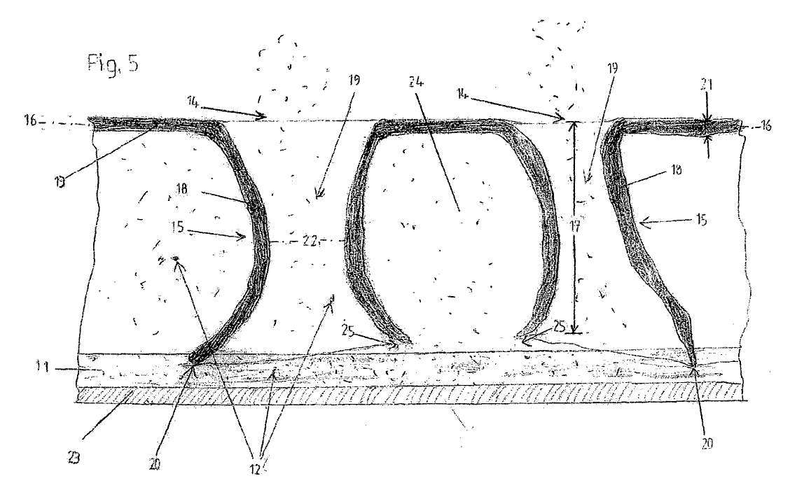

FIG. 5 a section through a composite having an outer layer wherein the protuberances project toward the adhesive layer,

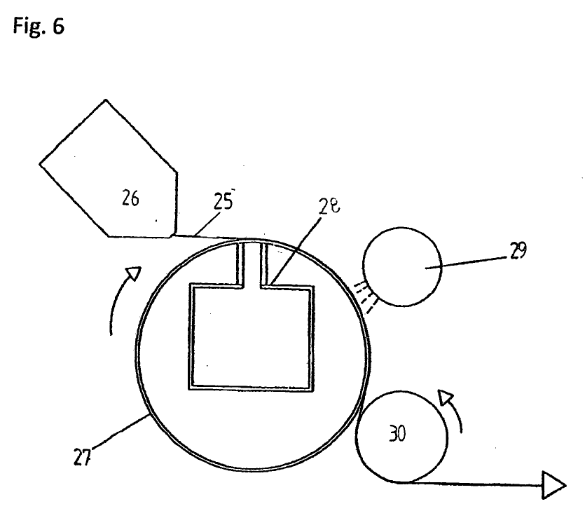

FIG. 6 a schematic diagram of a process for producing the outer layer,

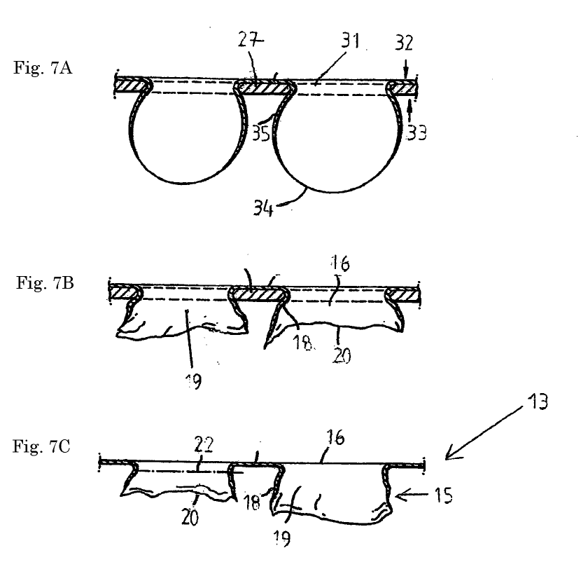

FIG. 7a the outer layer during the production process in an initial stage,

FIG. 7b the outer layer during the production process in a final stage,

FIG. 7c a section through the cooled outer layer.

FIG. 1 shows, in schematic form, a corrosion protection arrangement in the form of a bag 1. A corrosion-prone article 2 is arranged in the bag 1. The bag 1 has a zip closure 3. The bag consists of composite 4 comprising a plurality of film layers. In the variant according to FIG. 1, a corrosion inhibitor 12 is released from the bag 1 itself to the inner face of the bag 1 for corrosion protection of the article 2. The corrosion inhibitor 12, in a purely schematic manner, is shown as black dots.

FIG. 2 shows a corrosion protection arrangement in which, in a conventional bag 1 without active VCI ingredients, a leaf-like element 5 composed of a composite 4 is present, which releases a corrosion inhibitor 12. The advantage of this variant is that the bag 1 itself is manufactured from an inexpensive film material which does not include any corrosion inhibitor 12.

FIG. 3 shows a variant in which a composite 4 takes the form of a tape-like material which is wound around an article 2 for corrosion protection.

FIG. 4 shows a schematic diagram of a composite 4. The composite 4 comprises an adhesive layer 11 containing a corrosion inhibitor 12. The adhesive layer 11 is permanently bonded to an outer layer 13. The outer layer 13 consists of a thermoplastic material and has a multitude of orifices 14 for release of the active corrosion-inhibiting ingredient 12. The outer layer 13 used in the working example is a film of a polyethylene or a polypropylene.

The adhesive layer 11 in the working example consists of an isocyanate-based adhesive and contains a corrosion inhibitor 12. The corrosion inhibitor 12 may be a salt, for example nitrite compounds or amine salts such as dicyclohexylamine benzoate or diethanolamine nitrite. In the working example, the corrosion inhibitor 12 used is a chemical compound formed from ethanolamine and a carboxylic acid (carboxylate and amide), which has a water content of about 2%. The water content of the corrosion inhibitor brings about foaming of the adhesive layer and consequently an increase in the surface area of this layer. In this way, a large surface area is provided, from which the active substance for the corrosion protection can evaporate and precipitate on the surface of the metal article to be protected.

Appropriately, the adhesive used is a chemically setting reactive adhesive. In the working example, a solvent-free adhesive is used. This is preferably based on aliphatic and/or aromatic isocyanates. The adhesive used is more preferably a PUR adhesive. The adhesive appropriately has an NCO content of 8% to 9% by weight. The water present in the active VCI ingredient can react with the isocyanate groups of the adhesive to form CO2.

The adhesive layer 11 can be applied homogeneously and over the full area or in a pattern of adhesive areas and adhesive-free areas. Another possibility is application in the form of a sprayable adhesive and/or powder sprinkler, especially in the case of flatbed systems.

According to the invention, the outer layer 13 has protuberances 15 which project from a plane 16 of the outer layer 13 by a height 17.

Each protuberance 15 has a wall 18 which forms a cavity 19 and surrounds an orifice 14. The orifices 14 are surrounded by the outer edges 20 of the protuberances 15. The cavities 19 extend from the adhesive layer 11 as far as the orifices 14.

The height 17 of the protuberances 15 is greater by more than a factor of 5, especially more than a factor of 10, than the thickness 21 of the plane 16 of the outer layer 13.

In the working example, the cavities 19 have a narrowest cross section 22. Proceeding from this narrowest cross section 22, the cross section of the cavities 19 widens toward the orifices 14 and/or toward the adhesive layer 11. The cross section bounded by the outer edge 20 of each protuberance 15 forms the orifice 14. The cross section of the orifice 14 is larger than the smallest cross section 22 of a cavity 19.

The plane 16 of the outer layer 13 forms the smooth side of the outer layer 13. The protuberances 15 of the outer layer 13 form the structured side of the outer layer 13, which has a three dimensional configuration.

The cross section of the cavity 19 increases in the axial direction from the point with the narrowest cross section 22 as far as the free edge 20 of the protuberances 15. The narrowest cross section 22 of the cavity 19 lies in a plane which is adjacent to the plane 16 of the outer layer 13 and which is at a distance from the free edge 20 of the protuberances 15.

The outer edge 20 of the protuberances 15 has an irregularly lobed or folded form. In the working example shown in FIG. 4, the plane 16 of the outer layer 13 is on the adhesive layer 11.

The adhesive layer 11 bonds the outer layer 13 to the surface 23. The surface 23 is a carrier layer which, in the working example, consists of a polyethylene.

FIG. 5 shows a variant of the invention in which the orifices 14 are arranged in the plane 16 of the outer layer and the protuberances 15 project toward the adhesive layer 11. In the variant shown in FIG. 5, the plane 16 is arranged spaced apart from the adhesive layer 11. The outer edge 20 of the protuberances 15 projects at least partly into the adhesive layer 11.

As a result, spaces 24 are formed between adjacent protuberances 15. The active ingredient 12 accumulates in the spaces 24. Since the outer edge 20 of the protuberances 15 has an irregular structure, there are connecting sites 25 through which the corrosion inhibitor 12 migrates from the spaces 24 into the cavities 19 and is then released through the orifices 14. This construction increases the efficacy in the use of the arrangement, since there is enrichment of the volatile corrosion inhibitor 12. This is especially advantageous in the case of corrosion inhibitors 12 having a comparatively low vapor pressure.

In the process of the invention for producing a corrosion protection arrangement, several steps are used. The corrosion inhibitor 12 is introduced into an adhesive. In the working example, this is a corrosion inhibitor 12 which is formed by reaction of an amine component and a carboxylic acid with elimination of water. The water content of the active ingredient can be adjusted such that the amine component is quantitatively bound in the adhesive layer and/or consumed as the adhesive hardens.

In the process scheme shown in FIG. 6, the outer layer 13 of the invention is produced from a polymer film 25 in the molten state. Such a mode of production is also referred to as “inline perforation”. As already explained, the outer layer 13 can also be produced on the basis of a heated film, in which case such a process is referred to as “offline perforation”.

In the case of inline perforation, the molten polymer film is applied from a slot die 26 to an element 27 having holes. The element 27 in the working example is a rotating cylinder having bores. By means of a reduced pressure apparatus 28, a pressure differential is generated. The polymer film 25 is sucked into the perforated cylinder by the reduced pressure apparatus 28. As a result, the polymer melt takes the form of elongated protuberances 15.

After the cooling of the film by means of a cooling device 29, the outer layer 13 is removed by means of a roller 30.

The outer layer 13 is then bonded to a surface 23 in the form of a carrier layer via the active ingredient-containing adhesive. For this purpose, an adhesive layer 11 is applied to the carrier layer by means of an engraved roller (not shown). The carrier layer is laminated to the outer layer 13.

FIGS. 7a and 7b show two stages during the production process of the outer layer 13. Holes 31 are distributed homogeneously on the element 27, the thickness of which is in the order of magnitude of 0.2 mm. The holes 31 have a diameter of more than 0.4 mm, especially more than 0.6 mm, and less than 1.2 mm, especially less than 1.0 mm. In the diagrams of FIGS. 7a and 7b, a hot plastic film has been laid on, the starting thickness of which is preferably between 15 μm and 70 μm.

By means of a pressure differential which acts from the upper side of the film 32 to the lower side of the film 33, the film material is deformed through the holes 31 in the form of bubbles 34. The diameter of the bubbles is greater than the diameter of the holes 31. As a result, the film material is deformed laterally in a region 35 beyond the hole limits.

As a result of the degree of deformation extending beyond the elasticity level and because of the cooling that the film material undergoes particularly in the region of contact close to the element 27, only a limited degree of reverse deformation takes place. In the region 35, the greater diameter of the bubble material that exceeds the hole diameter is maintained for the most part, while the material component that previously formed the dome of the bubble draws back largely toward the region 35. Since the process of bursting does not proceed in a geometrically homogeneous manner, an edge 20 forms with a lobed, wavy, irregular, cracked and/or folded structure.

If, later on in the process, the film is removed from the element 27, the protuberances 15 formed can be pulled out of the holes 31 of the element 27; however, they keep the extended edge shape illustrated in FIG. 7c, which is partly responsible for the particularly advantageous characteristics.

The cavities 19 are shaped in that their diameter decreases proceeding from the plane 16 toward the narrowest cross section 22 and then increases again towards the edge 20. The narrowest diameter of the cavity is appropriately between 0.2 and 2 mm, preferably between 0.3 and 1.3 mm.

The outer layer 13 is extremely pleasant to the touch. This is because of the comparatively high ratio of the orifice area to the total area. The outer layer 13 is soft but nevertheless has good tensile strength. The reason for the softness is the yielding of the thinned-out protuberance edges. The good strength values are attributable to the fact that the zones of the smallest diameter of the protuberances in which the greatest stresses occur under tensile stress on the film do not simultaneously form the orifices, and are therefore not weakened by notch effects or fractions of particularly low material density.

Preferred materials for production of the outer layer 13 are polyolefins, including the homopolymers thereof, mixtures of homopolymers, copolymers, mixtures of different copolymers, and mixtures of copolymers and homopolymers.

1. A corrosion protection arrangement comprising an adhesive layer (11) containing at least one volatile corrosion inhibitor (12), wherein the adhesive layer (11) sticks to a surface (23) and the adhesive layer (11) bonds an outer layer (13) to the surface (23), wherein the outer layer (13) has a multitude of orifices (14) for release of the volatile corrosion inhibitor (12), characterized in that the outer layer (13) has protuberances (15) which project out of a plane (16) of the outer layer (13) by a height (17).

2. The arrangement as claimed in claim 1, characterized in that the surface (23) is formed by an outer face of a packaging material.

3. The arrangement as claimed in claim 1 or 2, characterized in that the outer layer (13) forms an inner layer of a packaging material.

4. The arrangement as claimed in any of claims 1 to 3, characterized in that the orifices (14) are formed by the protuberances (15).

5. The arrangement as claimed in claim 4, characterized in that each protuberance (15) has a wall (18) which forms a cavity (19) and surrounds an orifice (14).

6. The arrangement as claimed in any of claim 5, characterized in that the cross section of the cavity (19) increases from a narrowest cross section (22) toward the orifice (14).

7. The arrangement as claimed in any of claims 1 to 6, characterized in that the height (17) of the protuberances (15) is greater by more than a factor of 5, especially more than a factor of 10, than a thickness (21) of the plane (16) of the outer layer (13).

8. The arrangement as claimed in any of claims 1 to 7, characterized in that the height (17) of the protuberances (15) is more than 100 μm, especially more than 300 μm.

9. The arrangement as claimed in any of claims 1 to 8, characterized in that the height (17) of the protuberances (15) is less than 1500 μm, especially less than 1000 μm.

10. The arrangement as claimed in any of claims 1 to 9, characterized in that the protuberances (15) project away from the adhesive layer (11) and the orifices (14) are formed by an outer edge (20) of the protuberances (15).

11. The arrangement as claimed in any of claims 1 to 9, characterized in that the protuberances (15) project toward the adhesive layer (13) and the orifices (14) are arranged in the plane (16) of the outer layer (13).

12. The arrangement as claimed in claim 11, characterized in that spaces (24) are formed between adjacent protuberances (15).

13. The arrangement as claimed in any of claims 1 to 12, characterized in that an outer edge (20) of the protuberances (15) has an irregularly lobed and/or folded form.

14. A process for producing an arrangement as claimed in any of claims 1 to 13, comprising the following steps:
introducing a volatile corrosion inhibitor (12) into an adhesive,
guiding a thermoplastic material through an element (27) having holes (31), drawing thermoplastic material into the holes (31) by virtue of a pressure differential,
thinning out thermoplastic material in the region of the holes (31) and forming orifices (14),
forming an outer layer (13) with protuberances (15) while cooling the thermoplastic material,
bonding the outer layer (13) to a surface (23) by means of the active ingredient-containing adhesive.

15. The process as claimed in claim 14, characterized in that the thermoplastic material is applied to the element (27) as a melt.

16. The process as claimed in claim 14, characterized in that the thermoplastic material is guided through the element (27) as a heated film.

17. The process as claimed in any of claims 14 to 16, characterized in that the adhesive is applied to the surface (23) and/or the outer layer (13) as an adhesive layer (11).
